(19) United States
(12) Patent Application Publication
(10) Pub. No.: US 2011/0159399 A1
(43) Pub. Date: Jun. 30, 2011

(54) POWER GENERATION CELL FOR FUEL BATTERY

(75) Inventor: Takashi Kondo, Kariya-shi (JP)

(73) Assignee: TOYOTA SHATAI KABUSHIKI KAISHA, Kariya-shi, Aichi-ken (JP)

(21) Appl. No.: 13/062,495

(22) PCT Filed: Apr. 23, 2009
(86) PCT No.: PCT/JP2009/058055

§ 371 Date: Mar. 4, 2011

(30) Foreign Application Priority Data
Dec. 8, 2008 (JP) 2008-312397

(51) Int. Cl. H01M 8/04; H01M 8/10

(52) U.S. Cl. 429/480; 429/514

(57) ABSTRACT

An electrolyte membrane 16 is arranged inside first and second frames 13 and 14. The electrolyte membrane 16 has a first surface, on which an anode side electrocatalytic layer 17 is superimposed, and a second surface, on which a cathode side electrocatalytic layer 18 is superimposed. The electrocatalytic layer 17 has a surface on which an anode side gas flow path formation body 21 including a gas flow path 21c for supplying fuel gas is superimposed. Further, the electrocatalytic layer 18 has a surface on which a cathode side gas flow path formation body 22 including a gas flow path 22c for supplying oxidation gas is superimposed. The first and second gas flow path formation bodies 21 and 22 have surfaces on which first and second separators 23 and 24 are superimposed, respectively.

### FIELD OF THE INVENTION

The present invention relates to a fuel battery for a fuel battery system installed in, for example, an electric vehicle or the like.

### BACKGROUND OF THE INVENTION

A fuel battery generally includes a cell stack, which is a stack of power generation cells. As shown in FIG. 11, a power generation cell 12 includes two frames 13 and 14, which are arranged one above the other, and an electrode assembly 15, which is arranged at a coupled portion of the frames 13 and 14. The electrode assembly 15 includes a solid electrolyte membrane (hereinafter referred to as an electrolyte membrane) 16, an anode side electrocatalytic layer 17, and a cathode side electrocatalytic layer 18. The electrolyte membrane 16 includes an outer rim held between the two frames 13 and 14. The electrolyte membrane 16 includes an upper surface on which the electrocatalytic layer 17 is superimposed. Further, the electrolyte membrane 16 includes a lower surface on which the electrocatalytic layer 18 is superimposed. The electrocatalytic layer 17 includes an upper surface on which an anode side gas diffusion layer 19 is superimposed. The electrocatalytic layer 18 includes a lower surface on which a cathode side gas diffusion layer 20 is superimposed. The gas diffusion layer 19 includes an upper surface on which an anode side first gas flow path formation body 21 is superimposed. Further, the gas diffusion layer 20 includes a lower surface on which a cathode side second gas flow path formation body 22 is superimposed. The first gas flow path formation body 21 includes an upper surface bonded to a planar first separator 23. The second gas flow path formation body 22 includes a lower surface bonded to a planar second separator 24.

As shown in FIG. 12, the first and second gas flow path formation bodies 21 and 22 are formed by metal laths in which a plurality of hexagonal rings 21a (22a) are arranged in a zigzag manner. In the first and second gas flow path formation bodies 21 and 22, fuel gas (oxidation gas) flows through gas flow paths 21c (22c), which are formed by the rings 21a (22a) and their cavities 21b (22b) and which meander in a complex manner. FIG. 12 is an enlarged view showing part of the first and second gas flow path formation bodies 21 (22).

As shown in FIG. 11, a supply passage G1 and a discharge passage G2 are formed in the first and second frames 13 and 14. Hydrogen gas, which serves as the fuel gas, is supplied through the supply gas G1 to the gas flow path 21c of the anode side first gas flow path formation body 21. The fuel off gas that has passed through the gas flow path 21c of the first gas flow path formation body 21 is discharged out of the discharge passage G2. Further, air, which serves as oxidation gas, is supplied through a supply passage (not shown located at the rear side of the plane of FIG. 11) of the first and second frames 13 and 14 to a gas flow path of the cathode side gas flow path formation body 22. The oxidation off gas that has passed through the gas flow path is discharged out of a discharge passage (not shown, located at the front side of the plane of FIG. 11).

As shown by the arrow P in FIG. 11, hydrogen gas is supplied to the first gas flow path formation body 21 from a hydrogen gas supply source (not shown) through a supply passage G1. Further, air is supplied to the second gas flow path formation body 21 from an air supply source (not shown). This causes an electrochemical reaction in the power generation cell and generates power. During the power generation, a humidifier humidifies the hydrogen gas and oxygen gas. Thus, the hydrogen gas and oxygen gas contains humidification water (water vapor). Further, the power generation generates generation water in the cathode side electrocatalytic layer 18, the gas diffusion layer 20, and the second gas flow path formation body 22. The generation water and humidification water condense and form water drops W, which are discharged out of the discharge passage G2 by the oxidation off gas flowing through the gas flow path 22c of the gas flow path formation body 22. Some of the generation water permeates through the electrolyte membrane 16 as permeation water and enters the anode side electrocatalytic layer 17, the gas diffusion layer 19, and the gas flow path 21c of the first gas flow path formation body 21. The permeation water and humidification water condense and form water drops W, which are discharged out of the discharge passage G2 by the fuel off gas flowing through the gas flow path 21c of the first gas flow path formation body 21. A power generation cell for a fuel battery that is similar to the structure shown in FIG. 11 is disclosed in Japanese Laid-Open Patent Publication No. 2007-87768.

As shown in FIG. 12, the anode side first gas flow path formation body 21 is formed by a metal lath in which the hexagonal rings 21a are arranged in a zigzag manner. In the first gas flow path formation body 21, fuel gas flows through the gas flow path 21c, which is formed by the rings 21a and the cavities 21b and which meanders in a complex manner. Thus, water drops W may remain in the gas flow path 21c without being discharged out of the gas flow path 21c in the gas flow path formation body 21. In this manner, when water drops W remain in the gas flow paths 21c and 22c of the first and second gas flow path formation bodies 21 and 22, the water drops W deteriorate the electrolyte membrane 16 in the electrode assembly 15. As a result, the thickness of the electrolyte membrane 16 may be reduced, and the durability of the power generation cell may be shortened. Further, when the residual water drops W generate an abnormal (excessive) potential at the anode side electrocatalytic layer 17, platinum (catalyst) is ionized in the cathode side electrocatalytic layer 18. As a result, platinum (catalyst) may be released from the electrocatalytic layer 18, and the durability of the power generation cell may be shortened.

Impurities contained in the water drops W such as silicon (Si) may collect as water stain on the fibers forming the gas diffusion layers 19 and 20 such as carbon fibers. As a result, the gas diffusion effect of the gas diffusion layers 19 and 20 may be decreased, and the power generation efficiency may be lowered.

When the fuel battery is operated under a high load, the water drops W may not be sufficiently discharged from the gas flow path 21c of the first gas flow path formation body 21. In such a case, the fuel gas supplied to the electrode assembly 15 becomes non-uniform, and the water drops W that impede power generation move in an irregular manner. This may vary the generated power voltage, cause flooding, and decrease voltage stability.

Further, the residual water drops W in the gas flow paths 21c and 22c of the first and second gas flow path formation bodies 21 and 22 may increase pressure loss of the fuel gas and the oxidation gas. As a result, loss may be increased in a gas supplying device such as a compressor, and the power generation efficiency of the fuel battery may be decreased.

### SUMMARY OF THE INVENTION

The present invention is directed to a power generation cell for a fuel battery that improves durability, voltage stability, and power generation efficiency.

In some embodiments, the present invention provides a power generation cell for a fuel battery including an electrolyte membrane arranged inside a looped frame, an anode side electrocatalytic layer superimposed on a first surface of the electrolyte membrane, a cathode side electrocatalytic layer superimposed on a second surface of the electrolyte membrane, an anode side gas flow path formation body superimposed on a surface of the anode side electrocatalytic layer and including a gas flow path that supplies fuel gas, a cathode side gas flow path formation body superimposed on a surface of the cathode side electrocatalytic layer and including a gas flow path that supplies oxidation gas, and a separator superimposed on a surface of each gas flow path formation body. In the power generation cell, a water guide layer is arranged between each gas flow path formation body and the corresponding separator and includes a capillary shaped water passage. The water passage of the water guide layer absorbs water, which is generated in the gas flow path of each gas flow path formation body by a power generation action of the fuel cell. Further, a gas flow in the gas flow path forces the water in the water passage to a downstream side of the gas flow.

In this structure, when generation water, which is generated by the power generation action of the power generation cell, and humidification water, which is supplied by a humidifier, condense and form water drops that collect on the wall surface of the gas flow path in the gas flow path formation body, the water drops are absorbed by the capillary shaped water passage water guide layer. The water absorbed by the water passage of the water guide layer is forced to the downstream side of the gas flow by the fuel gas or oxidation gas flowing through the gas flow path. As a result, water drops are eliminated from the gas flow path of the gas flow path formation body, and deterioration of the electrode assembly is prevented. Further, fuel gas and oxidation gas is smoothly supplied to the electrode assembly. Thus, the power generation cell performs power generation properly.

In some embodiments, the water guide layer is formed from a conductive material.

In some embodiments, the gas flow path formation bodies are each formed by a metal lath including a plurality of rings having cavities, and the gas flow path formation bodies and the water guide layers are bonded with each other by pressing them in a superimposed state in their thicknesswise direction so that edges of the rings are caught in the water guide layer.

In some embodiments, the water guide layer is arranged throughout the entire surface of the gas flow path formation body.

In some embodiments, the water guide layer includes an extension extending to a downstream side of the gas flow path, and the extension is located in a discharge passage of the fuel gas or oxidation gas formed in the frame.

In some embodiments, the extension and an electrode assembly, which includes the electrolyte membrane, are connected to each other by a heat transmission plate.

In some embodiments, the water guide layer is formed using at least one selected from the group consisting of a woven or nonwoven fabric made from metal fibers, a metal porous body, a porous body made of resin and having undergone a conductive plating process, a porous body made of a conductive ceramic, and a porous body made of carbon and having a hydrophilic property.

### BRIEF DESCRIPTION OF THE DRAWINGS

FIG. 1 is a cross-sectional view showing a fuel battery according to one embodiment of the present invention;

FIG. 2 is a cross-sectional view showing a power generation cell of the fuel battery;

FIG. 3 is an exploded perspective view of the power generation cell;

FIG. 4 is partial perspective view of a gas flow path formation body;

FIG. 5 is a schematic diagram showing the operation for bonding the gas flow path formation body and a water guide layer;

FIG. 6 is an enlarged cross-sectional view showing an anode side of the fuel battery;

FIG. 7 is an enlarged cross-sectional view showing a cathode side of the fuel battery;

FIG. 8 is a partial cross-sectional view showing a power generation cell in a further example of the present invention;

FIG. 9 is a partial cross-sectional view showing a power generation cell in a further example of the present invention;

FIG. 10 is a plan view showing a gas flow path formation body in a further example of the present invention;

FIG. 11 is a cross-sectional view showing a power generation cell of a prior art fuel battery; and

FIG. 12 is a partial perspective view showing a gas flow path formation body used in the power generation cell of FIG. 11.

### DETAILED DESCRIPTION

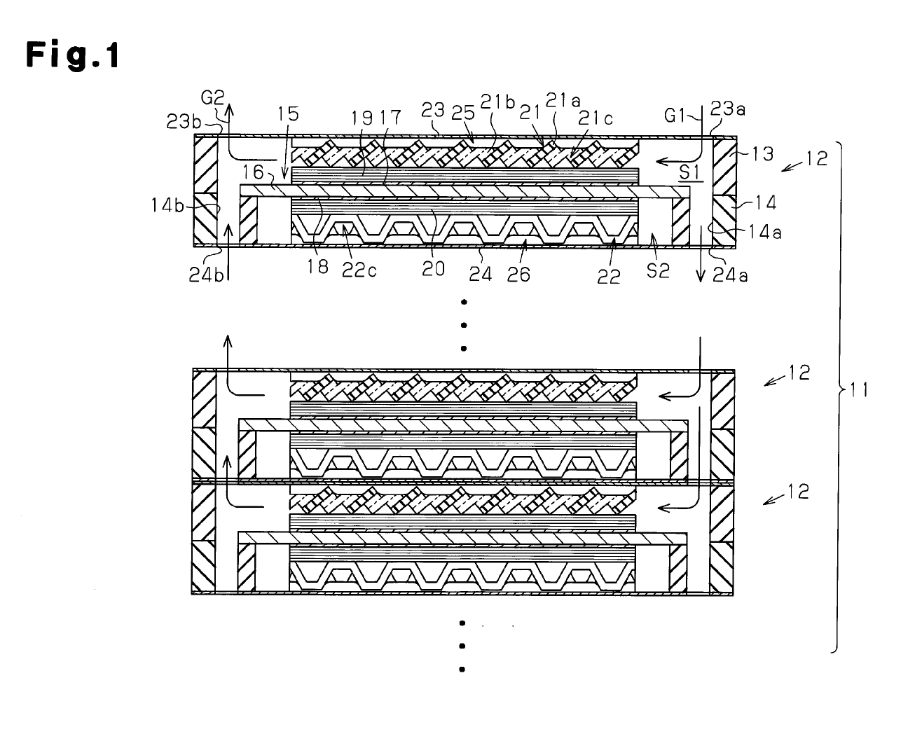

A fuel battery according to one embodiment of the present invention will now be discussed with reference to FIGS. 1 to 7.

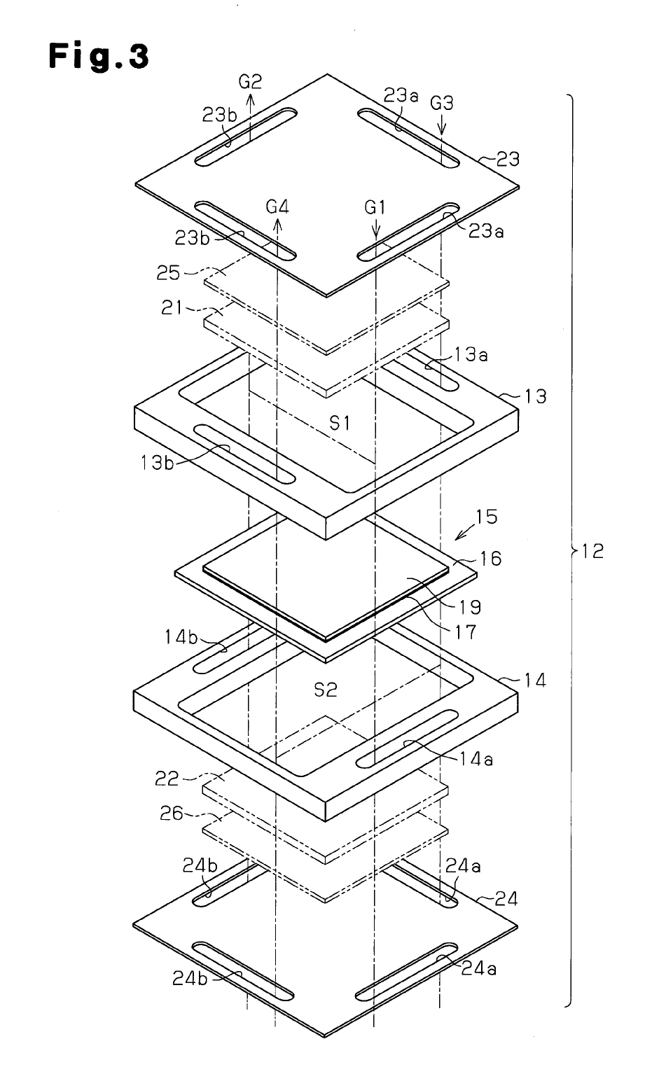

As shown in FIGS. 1 and 3, a solid polymer fuel battery stack 11 is formed by stacking a plurality of power generation cells 12.

As shown in FIG. 1, a power generation cell 12 is formed to have the shape of a square frame. The power generation cell 12 includes first and second frames 13 and 14, which are formed from a synthetic rubber (or synthetic resin), and a membrane-electrode-assembly) MEA 15, which serves as an electrode assembly arranged between the two frames 13 and 14. The first and second frames 13 and 14 include a fuel gas passage opening S1 and an oxidation gas passage opening S2. Further, the power generation cell 12 includes a first gas flow path formation body 21, which is accommodated in the fuel gas passage opening S1, and a second gas flow path formation body 21, which is accommodated in the oxidation gas passage opening S2. The first gas flow path formation body 21 is formed from ferrite stainless steel (SUS), which is conductive. The second gas flow path formation body 22 is formed from titanium or gold, which are conductive. Further, the power generation cell 12 includes a first separator 23, which is adhered to an upper surface of the first frame 13, and a second separator 24, which is adhered to a lower surface of the second frame 14. The first and second separators 23 and 24 are each formed from titanium, which is conductive, and has the shape of a flat plate. A first water guide layer 25 is arranged between an upper surface of the first gas flow path formation body 21 and a lower surface of the first separator 23. Further, a second water guide layer 26 is arranged between a lower surface of the second gas flow path formation body 22 and an upper surface of the second separator 24. FIG. 3 shows the first and second gas flow path formation bodies 21 and 22 and the first and second water guide layers 25 and 26 in a simplified manner as flat plates.

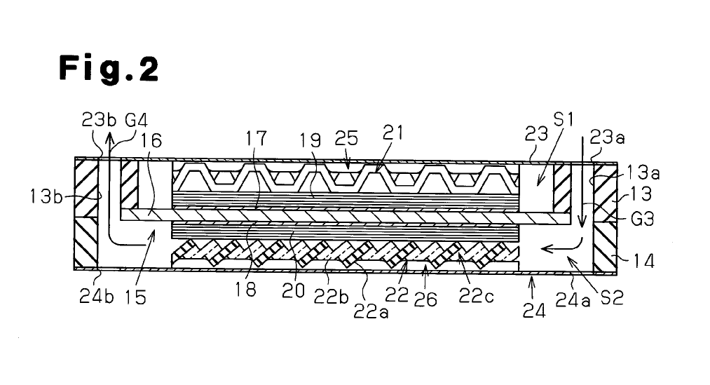

As shown in FIGS. 1 and 2, the MEA 15 includes an electrolyte membrane 16, electrocatalytic layers 17 and 18, and conductive gas diffusion layers 19 and 20. The electrocatalytic layer 17 is an anode side electrocatalytic layer and formed by superimposing a predetermined catalyst on an upper surface (first surface) of the electrolyte membrane 16. The electrocatalytic layer 18 is a cathode side electrocatalytic layer and formed by superimposing a predetermined catalyst on a lower surface (second surface) of the electrolyte membrane 16. The gas diffusion layers 19 and 20 are respectively adhered to the surfaces of the electrocatalytic layers 17 and 18.

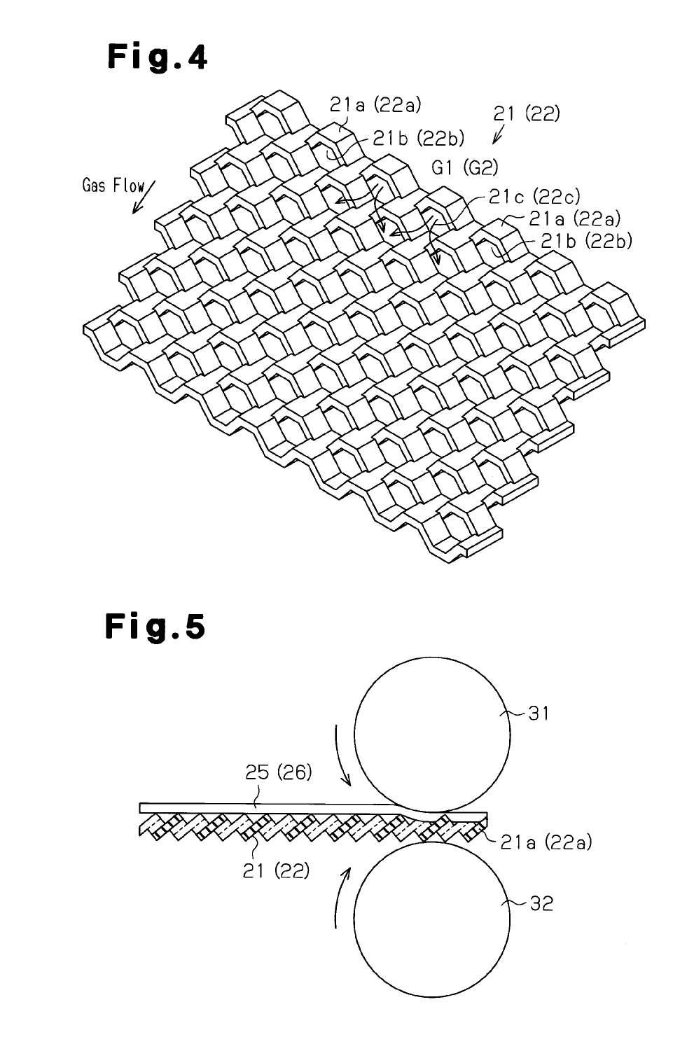

The electrolyte membrane 16 is formed by a fluorine polymer membrane. The electrocatalytic layers 17 and 18 are formed by applying carbon having a grain diameter of several microns to the surface of a catalyst. To increase the power generation efficiency of the fuel battery, for example, grains of platinum (Pt) having a grain diameter of 2 nm are used for the catalyst. The gas diffusion layers 19 and 20 are formed from conductive carbon paper. As shown in FIG. 4, the first and second gas flow path formation bodies 21 (22) are formed by metal laths in which a plurality of hexagonal rings 21a (22a) are arranged in a zigzag manner. In the first and second gas flow path formation bodies 21 (22), fuel gas (oxidation gas) flows through gas flow paths 21c (22c), which are formed by the rings 21a (22a) and their cavities 21b (22b). FIG. 4 shows only part of the first and second gas flow path formation bodies 21 (22).

As shown in FIG. 3, the fuel gas passage opening S1 of the first frame 13 has a tetragonal shape when viewed from above. A gas inlet 13a and a gas outlet 13b, which are elongated holes, are formed along two parallel sides of the first frame 13. A gas inlet 14a and a gas outlet 14b are formed along two parallel sides of the second frame 14. The gas inlet 14a and the gas outlet 14b are respectively formed at positions that do not correspond to the gas inlet 13a and gas outlet 13b of the first frame 13. Gas inlets 23a and gas outlets 23b are formed along two parallel sides of the first separator 23. Gas inlets 24a and gas outlets 24b are formed along two parallel sides of the second separator 24.

As shown in FIG. 1, in the fuel gas passage opening S1 of the first frame 13, the first gas flow path formation body 21 is in contact with the surface of the gas diffusion layer 19 and the inner surface of the first water guide layer 25. In the fuel gas passage opening S2 of the second frame 14, the second gas flow path formation body 22 is in contact with the surface of the gas diffusion layer 20 and the inner surface of the second water guide layer 26.

The first gas flow path formation body 21 encloses fuel gas drawn into the fuel gas passage opening S1 from a supply passage G1 shown in FIG. 1, that is, the first gas inlet 23a of the first separator 23, so that the fuel gas flows to a discharge passage G2, or the first gas outlet 23b of the first separator 23, to the gas outlet 14b of the second frame 14, and to the first gas outlet 24b of the second separator 24. The second gas flow path formation body 22 encloses oxidant gas drawn into the oxidation gas passage opening S2 of the second frame 14 from a supply passage G3 shown in FIG. 2, or the second gas inlet 23a of the first separator 23, through the gas inlet 13a so that the oxidation gas flows to a discharge passage G4, or the second gas outlet 23b, through the gas outlet 13b of the first frame 13 and also to the second gas outlet 24b of the second separator 24.

As shown in FIG. 1, the supply passage G1 and the discharge passage G2 are in communication through the gas flow path 21c of the first gas flow path formation body 21 between the stacked power generation cells 12 of the fuel battery stack 11 to form a fuel gas (hydrogen gas) circulation path. Further, the supply passage G3 and the discharge passage G4 are in communication through the gas flow path 22c of the second gas flow path formation body 22 between the power generation cells 12 to form an oxidation gas (air) circulation path. Due to the first gas flow path formation body 21, the fuel gas supplied to the fuel gas passage opening S1 flows in the fuel gas passage opening S1 in a uniformly diffused state. In the fuel gas passage opening S1, the fuel gas produces turbulence when passing through the gas flow path 21c of the first gas flow path formation body 21. This uniformly diffuses fuel gas in the fuel gas passage opening S1. The fuel gas is diffused when passing through the gas diffusion layer 19 and uniformly supplied to the electrocatalytic layer 17. Further, in the electrode assembly 15, an electrode reaction occurs when fuel gas and oxidation gas is supplied. This generates power. The desired output is obtained by stacking a plurality of the power generation cells 12.

The main structure of this embodiment will now be described.

As shown in FIG. 1, the first water guide layer 25 is arranged between the anode side first gas flow path formation body 21 and the first separator 23 throughout the first gas flow path formation body 21. The first water guide layer 25 is formed from a nonwoven fabric made from elastically deformable fibers of metal, such as stainless steel, copper, silver, and gold. In some embodiments, the first gas flow path formation body 21 and the first water guide layer 25 are formed from the same material to prevent corrosion caused by contact between different types of metal. The second water guide layer 26 is arranged between the cathode side second gas flow path formation body 22 and the second separator 24 throughout the second gas flow path formation body 22. In the same manner as the first water guide layer 25, the second guide layer is formed by a nonwoven fabric of metal fibers. In this manner, the first and second water guide layers 25 and 26 are each formed from a nonwoven fabric made of metal. Water passages 25a and 26a, which are in the form of capillaries (porous), are formed on the first and second water guide layers 25 and 26. The water passages 25a have a passage area that is smaller than that of the cavities 21b of the first gas flow path formation body 21. The water passages 26a have a passage area that is smaller than that of the cavities 22b of the second gas flow path formation body 22. Thus, the water drops W that collect on the wall surface of the gas flow path 21c in the first gas flow path formation body 21 is absorbed by the water passage 25a of the first water guide layer 25. Further, the water drops W that collect on the wall surface of the gas flow path 22c in the second gas flow path formation body 22 is absorbed by the water passage 26a of the second water guide layer 26.

As show in FIG. 5, motors (not shown) rotate bonding rollers 31 and 32 in the directions indicated by the arrows. The bonding rollers 31 and 32 press the first gas flow path formation body 21 and the first water guide layer 25 for upper and lower directions with a predetermined pressure. As shown in FIG. 1, the pressing with the bonding rollers 31 and 32 results in the edges of the rings 21a in the first gas flow path formation body 21 getting caught in the first water guide layer 25. This bonds the first gas flow path formation body 21 and the first water guide layer 25 with each other. The bonding operation with the bonding rollers 31 and 32 are also performed on the second gas flow path formation body 22 and the second water guide layer 26. As shown in FIG. 2, this results in the edges of the rings 22a in the second gas flow path formation body 22 getting caught in the second water guide layer 26 and bonds the second gas flow path formation body 22 and second water guide layer 26 to each other.

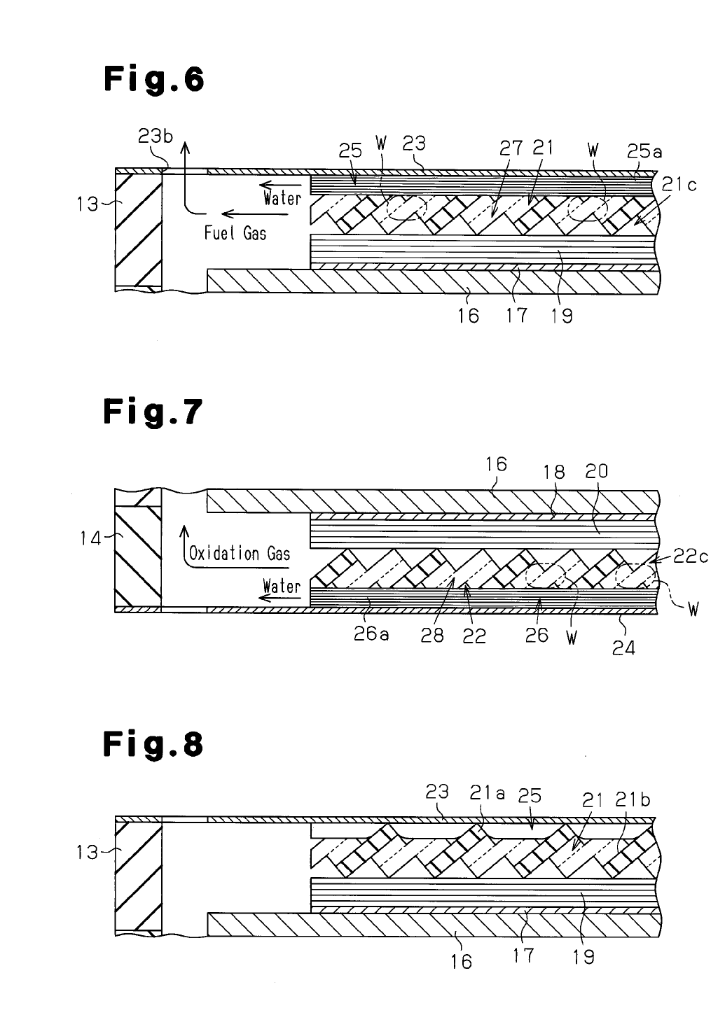

As shown in FIG. 1, the rings 21a in the first gas flow path formation body 21 compress part of the anode side first water guide layer 25 toward the first separator 23. This substantially closes the compressed first water passage 25a. However, as shown in FIG. 4, the first gas flow path formation body 21 includes the gas flow path 21c, which meanders in a complex manner. Thus, as shown in FIG. 6, the water passage 25a in the first water guide layer 25 that corresponds to the gas flow path 21c does not close in the anode side first water guide layer 25. This sustains the water passage function of the water passage 26a. As shown in FIG. 7, the water passage 26a in the second water guide layer 26 that corresponds to the gas flow path 22c does not close in the cathode side second water guide layer 26. This sustains the water passage function of the water passage 26a. FIGS. 6 and 7 respectively show the cross-sections of a single one of the gas flow paths 21c and 22c in a simplified manner.

The operation of the fuel battery will now be described.

When the fuel battery generates power, as described in the background art section, generation water is generated at the cathode side of the electrode assembly, and permeation water is generated at the anode side. Further, a humidifier generates humidification water in the fuel gas supplied to the gas flow path 21c in the first gas flow path formation body 21. As shown in FIG. 6, the permeation water and the humidification water condense into water drops W in the gas flow path 21c of the first gas flow path formation body 21. When the water drops W come into contact with the first water guide layer 25 due to surface tension, capillary action causes the water drops W to permeate into the water passage 25a of the first water guide layer 25. This eliminates the water drops W from the gas flow path 21c. The water drawn into the water passage 25a of the first water guide layer 25 is gradually forced toward the downstream side of the gas flow by the pressure of the fuel gas flowing through the gas flow path 21c and drained into the discharge passage G2 for fuel off gas.

When the fuel battery generates power, generation water is generated at the cathode side. Further, the humidifier also generates humidification water in the oxidation gas supplied to the gas flow path 22c in the second gas flow path formation body 22. As shown in FIG. 7, the generation water and the humidification water enter the gas flow path 22c of the second gas flow path formation body 22 and condense into water drops W. When the water drops W come into contact with the second water guide layer 26 due to surface tension, capillary action causes the water drops W to permeate into the water passage 26a of the second water guide layer 26. This eliminates the water drops W from the gas flow path 22c. The water permeating into the second water guide layer 26 is gradually forced toward the downstream side of the gas flow by the pressure of the oxidation gas flowing through the gas flow path 22c and sent to the discharge passage G4 for oxidation off gas.

The fuel battery of the above-discussed embodiment has the advantages described below.

(1) The first water guide layer 25 is arranged between the first gas flow path formation body 21 and the first separator 23, and the second water guide layer 26 is arranged between the second gas flow path formation body 22 and the second separator 24. Thus, when the fuel battery generates power, the water drops W condensed in the gas flow paths 21c (22c) of the first and second gas flow path formation bodies 21 (22) are discharged through the first and second water guide layers 25 (26). As a result, the water drops W are eliminated from the gas flow paths 21c (22c) of the first and second gas flow path formation bodies (22). This prevents deterioration of the electrode assembly 15 and the gas diffusion layers 19 (20) and improves the durability of the power generation cell 12.

(2) There is no residual water drops W in the gas flow paths 21c (22c) of the first and second gas flow path formation bodies 21 (22). Thus, fuel gas (oxidation gas) is smoothly supplied from the gas flow path 21c (22c) to the gas diffusion layers 19 (20). This results in proper cell reactions. Thus, the power generation voltage is stabilized, and the power generation efficiency is improved.

3) Water drops W do not remain in the gas flow paths 21c (22c) of the first and second gas flow path formation bodies 21 (22). Thus, fuel gas (oxidation gas) flows smoothly through the gas flow paths 21c (22c). This reduces pressure loss of the fuel gas (oxidation gas) in the gas flow paths 21c (22c). As a result, the fuel battery can be operated with a lower gas supplying pressure. This allows for reduction in size of a gas supplying device such as a compressor and improves the heat generation efficiency.

(4) The first and second water guide layers 25 (26) are formed from a conductive material. Thus, even though the first and second guide water layers 25 (26) are held between the conductive first and second gas flow path formation bodies 21 (22) and the conductive first and second separators 23 (24) in which the first and second gas flow path formation bodies 21 (22) are in a non-contact state with the first and second separators 23 (24), the first and second water guide layers 25 (26) electrically connect the first and second gas flow path formation bodies 21 (22) to the first and second separators 23 (24). That is, the edges of the rings 21a (22a) of the first and second gas flow path formation bodies 21 (22) can be electrically connected to the first and second separators 23 (24). Thus, there is no need to form pores in the first and second water guide layers 25 (26). This facilitates manufacturing of the fuel battery.

(5) The first and second water guide layers 25 (26) partially enter the gas flow paths 21c (22c) of the first and second gas flow path formation bodies 21 (22), and the first and second water guide layers 25 (26) are partially caught in the first and second water guide layers 25 (26). Thus, water drops W easily contact the first and second water guide layers 25 (26), and the first and second water guide layers 25 (26) easily absorb the water drops W.

(6) The first and second water guide layers 25 (26) are arranged throughout the entire surface of the first and second gas flow path formation bodies 21 (22). Thus, water drops W are prevented from remaining throughout the entire gas flow paths 21c (22c) of the first and second gas flow path formation bodies.

The above-discussed embodiment may be modified as described below.

As shown in FIG. 8, the edges of the rings 21a (22a) in the first and second gas flow path formation bodies 21 (22) may be in contact with the first and second separators 23 (24). In this case, the first and second gas flow path formation bodies 21 (22) are electrically connected to the first and second separators 23 (24). Thus, the first and second water guide layers 25 (26) may be formed from a non-conductive material. This improves the degree of freedom for selection of the material of the first and second water guide layers.

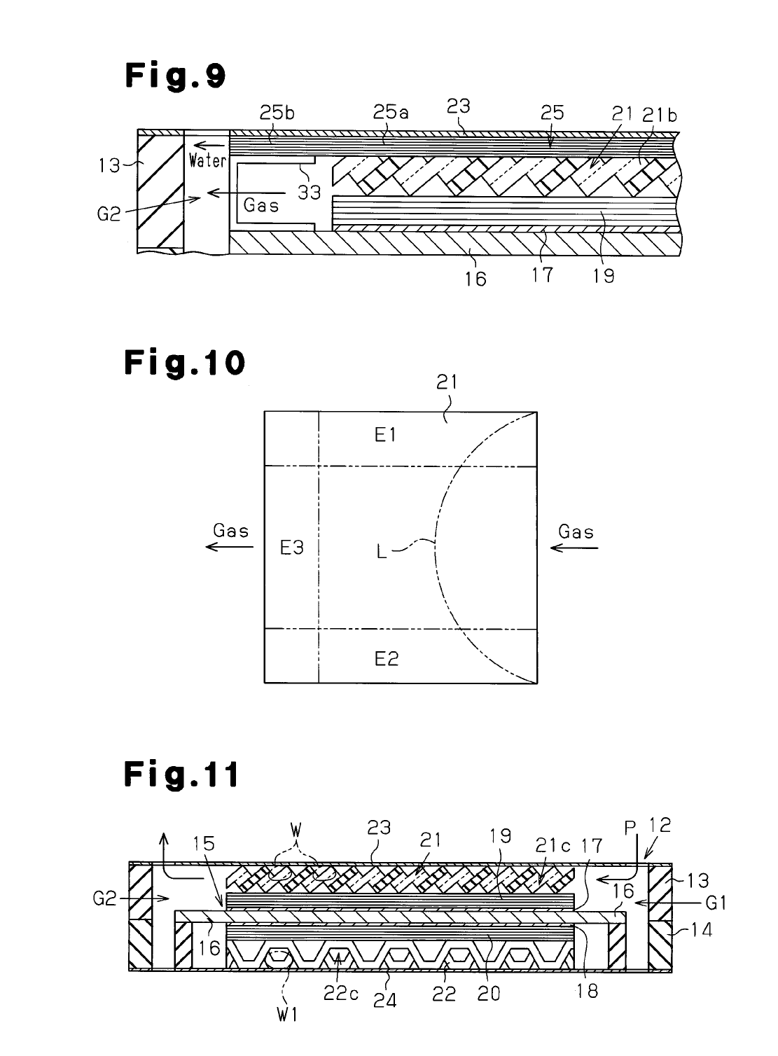

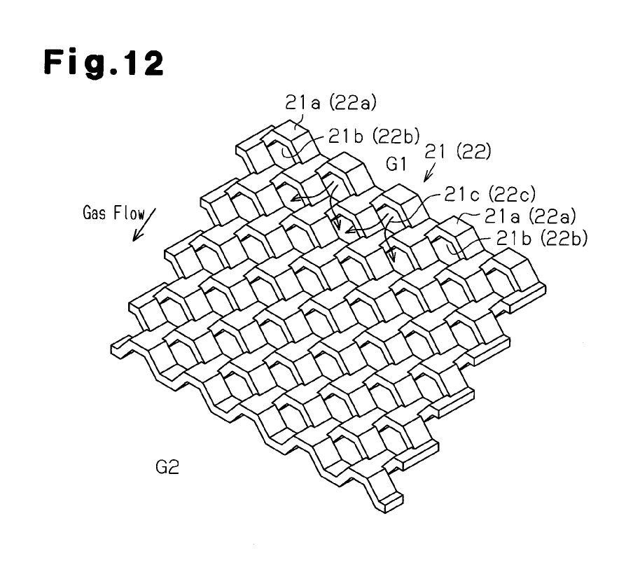

As shown in FIG. 9, an extension 25b may be formed extending toward the discharge passage G2 at the end of the first water guide layer 25 that is proximal to the discharge passage G2. Further, the extension 25b and the electrode assembly 15 (electrolyte membrane 16) may be connected by a heat transmission plate 33, which has a high thermal conductivity. In this case, fuel gas, which has a high temperature due to power generation, heats the extension 25b. This vaporizes and eliminates the water that is present in the water passage 25a of the extension 25b. Thus, the extension 25b efficiently absorbs water from the water passage 25a of the first water guide layer 25. This enhances water drainage from the water passage 25a of the first water guide layer 25. Further, the heat generated at the electrolyte membrane 16 and the electrocatalytic layers 17 and 18 due to power generation by the fuel battery may be transmitted to the extension 25b through the heat transmission plate 33. This further enhances vaporization of the water that is present in the water passage 25a of the extension 25b. Thus, water drainage from the water passage 25a of the first water guide layer 25 is further enhanced.

FIG. 10 is a schematic plan view showing the first gas flow path formation body 21. The flow velocity of the fuel gas flowing through the gas flow path 21c (refer to FIG. 4) is faster as the central part of the first gas flow path formation body 21 becomes closer and slower as the left and right sides of the first gas flow path formation body 21 becomes closer. Further, there is a tendency for water drops W to remain in the downstream side of the gas flow path in the first gas flow path formation body. That is, water has a tendency to remain in the left and right sides of the first gas flow path formation bodies 21. Thus, the first water guide layer 25 may be arranged in just areas E1 and E2, which are shown by the double-dashed lines at the left and right sides of the first gas flow path formation bodies 21, just area E3, which is shown by the double-dashed lines at the downstream side, or just the areas E1, E2, and E3.

As the conductive first and second water guide layers 25 and 26, for example, a porous body including capillary-shaped water passages, a porous body including capillary-shaped water passages made of resin and having undergone a conductive plating process, a porous body including capillary-shaped water passages made of a conductive ceramic, or a porous body including capillary-shaped water passages made of carbon and having a hydrophilic property may be used.

As the material of the first and second gas flow path formation bodies 21 and 22, for example, metal plates of aluminum, copper, or the like may be used.

The gas diffusion layers 19 and 20 may be eliminated from the fuel battery.

1. (canceled)

2. The power generation cell for a fuel battery according to claim 6, wherein the water guide layer is formed from a conductive material.

3. The power generation cell for a fuel battery according to claim 6, wherein the gas flow path formation bodies are each formed by a metal lath including a plurality of rings having cavities, and the gas flow path formation bodies and the water guide layers are bonded with each other by pressing them in a superimposed state in their thicknesswise direction so that edges of the rings are caught in the water guide layer.

4. The power generation cell for a fuel battery according to claim 6, wherein the water guide layer is arranged throughout the entire surface of the gas flow path formation body.

5. The power generation cell for a fuel battery according to claim 6,
wherein the extension is located in a discharge passage of the fuel gas or oxidation gas formed in the frame.

6. A power generation cell for a fuel battery including:
an electrolyte membrane arranged inside a looped frame;
an anode side electrocatalytic layer superimposed on a first surface of the electrolyte membrane;
a cathode side electrocatalytic layer superimposed on a second surface of the electrolyte membrane;
an anode side gas flow path formation body superimposed on a surface of the anode side electrocatalytic layer and including a gas flow path that supplies fuel gas;
a cathode side gas flow path formation body superimposed on a surface of the cathode side electrocatalytic layer and including a gas flow path that supplies oxidation gas;
a separator superimposed on a surface of each gas flow path formation body; and
a water guide layer arranged between each gas flow path formation body and the corresponding separator and including a capillary shaped water passage,
wherein the water passage of the water guide layer absorbs water, which is generated in the gas flow path of each gas flow path formation body by a power generation action of the fuel cell, and a gas flow in the gas flow path forces the water in the water passage to a downstream side of the gas flow,
wherein the water guide layer includes an extension extending to a downstream side of the gas flow path, and
wherein the extension and an electrode assembly, which includes the electrolyte membrane, are connected to each other by a heat transmission plate.

7. The power generation cell for a fuel battery according to claim 6, wherein the water guide layer is formed using at least one selected from the group consisting of a woven or nonwoven fabric made from metal fibers, a metal porous body, a porous body made of resin and having undergone a conductive plating process, a porous body made of a conductive ceramic, and a porous body made of carbon and having a hydrophilic property.
